(19) United States
(12) Patent Application Publication
(10) Pub. No.: US 2014/0182555 A1
(43) Pub. Date: Jul. 3, 2014

(54) ENGINE WITH DUAL INJECTOR

(71) Applicant: HYUNDAI MOTOR COMPANY, Seoul (KR)

(72) Inventors: Joon Won Lim, Seoul (KR); Chun Woo Lee, Suwon-si (KR); In Gee Suh, Yongin-si (KR); Hyung Ju Lee, Seoul (KR); II Joong Hwang, Gunpo-si (KR); Woo Tae Kim, Anyang-si (KR)

(73) Assignee: Hyundai Motor Company, Seoul (KR)

(21) Appl. No.: 13/856,808

(22) Filed: Apr. 4, 2013

(30) Foreign Application Priority Data
Dec. 27, 2012 (KR) 10-2012-0154119

(51) Int. Cl. F02M 57/04

(52) U.S. Cl. CPC F02M 57/04
USPC 123/470

(57) ABSTRACT

An engine includes two injectors that inject fuel in an intake port connected with one combustion chamber and allows overcoming the technical limits of the related art and achieving more appropriate fuel injection in accordance with the operation sections of an engine, thereby improving fuel efficiency and output of the engine with more efficient operation.

### CROSS-REFERENCE TO RELATED APPLICATION

The present application claims priority of Korean Patent Application Number 10-2012-0154119 filed Dec. 27, 2012, the entire contents of which application is incorporated herein for all purposes by this reference.

### BACKGROUND OF INVENTION

1. Field of Invention

The present invention relates to an engine with dual injector, and more particularly, to a technology relating a position to install an injector.

2. Description of Related Art

Since common engines of the related art are equipped with only one injector in the intake port, the amount of entire fuel supplied to the combustion chamber is controlled to be injected by one injector and the vaporized fuel is introduced into the combustion chamber by injecting the fuel before the opening of intake valve, thereby vaporization is decreased by wall wetting.

On the other hand, in dual injector engines, in order to improve fuel efficiency by increasing a volume efficiency and to reduce toxic substances, as illustrated in FIG. 1, an injector 502 is disposed in each of two intake ports 500 connected with one combustion chamber respectively and fuel can be appropriately supplied to the combustion chamber by controlling the two injectors 502.

The fuel for one combustion chamber is supposed to be injected by two injectors 502 in the engine with a duel injector, and the improvement of fuel efficiency by an increase of volume efficiency is maximized only when the fuel is injected with the opening of the intake valve.

However, it is advantageous that the fuel is vaporized inside the combustion chamber in order to maximize the volume efficiency in a high-load section depending on the operation section of the engine; therefore, it is advantageous to disposed the injector close to the intake valve; however, it is advantageous to dispose the injector far from the intake valve for advantageous mixing and vaporizing of the fuel in a low-load section.

Meanwhile, it does not become a problem to dispose the injector relatively far from the intake valve, but there is a limitation in disposing the injector close to the intake valve due to problems such as interference with a valve operation mechanism, as shown in FIG. 2, so it is difficult to dispose the injector 502 within about 60 mm from the top of the intake valve 504 in the related art.

The information disclosed in this Background section is only for enhancement of understanding of the general background of the invention and should not be taken as an acknowledgement or any form of suggestion that this information forms the prior art already known to a person skilled in the art.

### BRIEF SUMMARY

Various aspects of the present invention provide for an engine with dual injector which includes two injectors in an intake port connected with one combustion chamber, which can implement more appropriate fuel injection in accordance with the operation sections of the engine while overcoming the technical limit of the related art, which can correspondingly improve fuel efficiency and output with more efficient operation of the engine.

Various aspects of the present invention provide for an engine with dual injector including: an intake port connected/disconnected to/from a combustion chamber by an intake valve; a first injector disposed relatively far from the intake valve in the intake port; and a second injector disposed under the intake port relatively closer to the intake valve than the first injector in the intake port and injecting fuel into the intake port above the intake valve.

Various aspects of the present invention provide for a method of controlling an engine with dual injector including: increasing the amount of injection from the first injector more than the amount of injection from the second injector in the low-load section of the engine; and increasing the amount of injection from the second injector more than the amount of injection from the first injector in the high-load section of the engine.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a view illustrating an engine with dual injector of the related art.

FIG. 2 is a view illustrating positions to dispose injectors in the engine with dual injector.

FIG. 3 is a view illustrating an exemplary engine with dual injector according to the present invention.

FIG. 4 is a view showing the configuration of the engine with dual injector according to the present invention, seen from above in FIG. 3.

FIG. 5 is a view illustrating an exemplary method of controlling the engine with dual injector of the present invention.

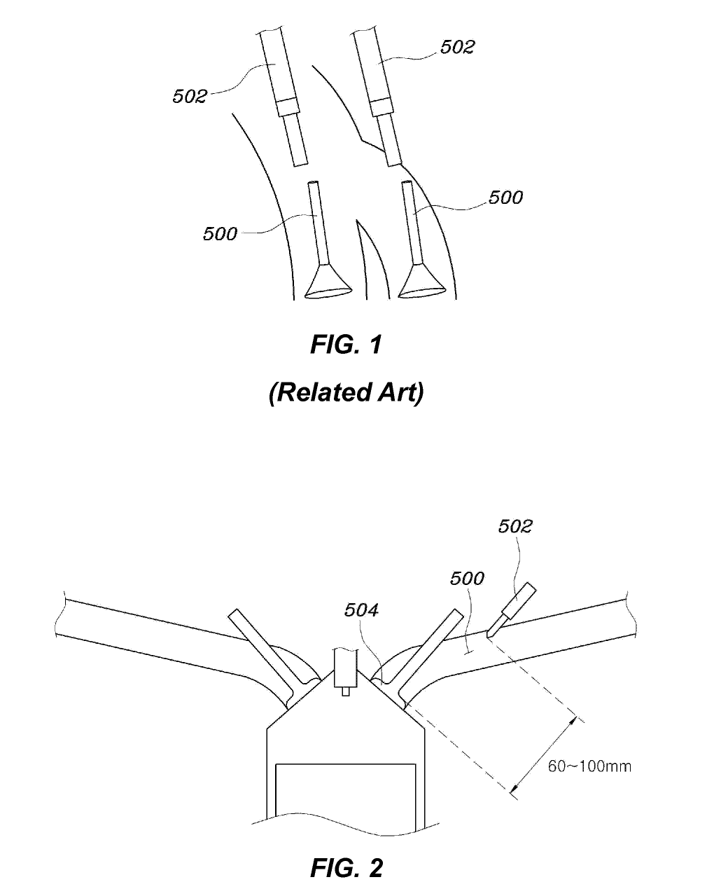

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

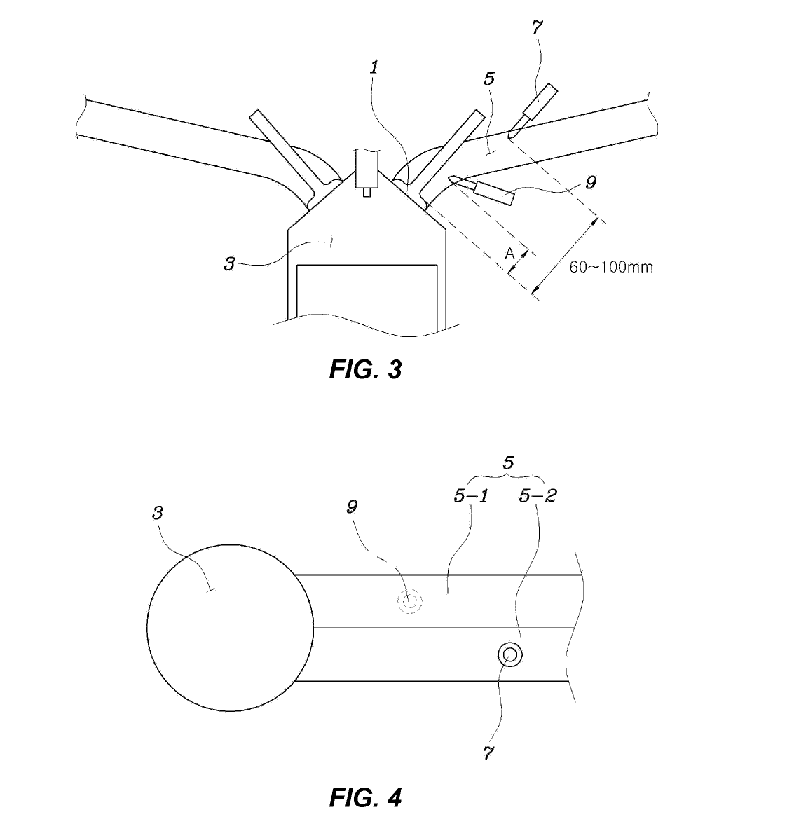

Referring to FIGS. 3 to 4, various embodiments of an engine with dual injector of the present invention may include: an intake port 5 connected/disconnected to/from a combustion chamber 3 by an intake valve 1; a first injector 7 disposed relatively far from the intake valve 1 in the intake port 5; and a second injector 9 disposed at the lower portion of the intake port 5 relatively closer to the intake valve 1 than the first injector 7 in the intake port 5 in order to inject fuel into the intake port 5 above the intake valve 1.

That is, the fuel for one combustion chamber 3 is separately injected by the first injector 7 and the second injector 9 while the first injector 7 is disposed relatively far from the intake valve 1 and the second injector 9 is disposed relatively close to the intake valve 1, in order to improve the output and the fuel efficiency of the engine by supplying the fuel more efficiently in all the operation sections of the engine, with injection control using the advantages at the positions.

In particular, since the second injector 9 is disposed at the lower portion of the intake port 5, it is possible to overcome the problems of difficulties in disposing an injector within 60 mm from the top of the intake valve 1, which is considered as a technical limit in the related art, and disposing an injector within about 45 mm from the top of the intake valve 1 without interfering with a valve operation mechanism of the intake valve 1; therefore, it is possible to achieve more improved fuel injection optimization.

The intake port 5 is composed of two intake ports 5-1 and 5-2 connected with one combustion chamber 3 while the first injector 7 and the second injector 9 are separately disposed in the intake ports 5-1 and 5-2, respectively.

Obviously, it may be possible to dispose the first injector 7 and the second injector 9 in only one intake port 5 in an engine with tow intake ports 5 connected with one combustion chamber 3.

The first injector 7 is positioned at a distance from the intake valve 1 which is longer than a predetermined reference distance to be suitable for mixing and vaporizing of fuel in a gas mixture in a low-load operation of the engine while the second injector 9 is positioned at a distance from the intake valve 1 which is longer than the predetermined reference distance A so that the fuel in the gas mixture may be vaporized in the combustion chamber 3 in a high-load operation of the engine.

For example, the predetermined reference distance A may be set within the range of 45 mm±5 mm and may be set by an experiment and analysis so that the feature of vaporizing the fuel injected from the injector directly in the combustion chamber 3 and the feature of sufficiently vaporizing the fuel in the gas mixture which is flowing through the intake port 5 may be discriminated.

In particular, according to the present invention, it is possible to implement optimum fuel injection very close to the intake valve 1 in comparison with the related art by mounting the second injector 9 at the lower portion of the intake port 5 while completely avoiding the interference with the valve operation mechanism, when it is necessary to inject fuel from a position within 45 mm from the top of the intake port 1 in order to vaporize the fuel injected from the injector directly in the combustion chamber 3, as described above.

Meanwhile, similar to common injectors of the related art, the first injector 7 can inject fuel into the intake port 5 by being disposed at the upper portion of the intake port 5, but the first injector 7 may also be disposed at the lower portion of the intake port 5, if necessary.

A method of controlling the engine with dual injector having the configuration described above is to increase the amount of injection from the first injector 7 more than the amount of injection from the second injector 9 in the low-load section of the engine and to increase the amount of injection from the second injector 9 more than the amount of injection from the first injector 7 in the high-load section of the engine.

That is, the method is focused on allowing intake air to be mixed with fuel and the fuel to be smoothly vaporized with a sufficient time while the intake air flows into the combustion chamber 3 through the intake port 5 by relatively increasing the amount of injection from the first injector 7 disposed relatively far from the intake valve 1 in the low-load section of the engine, and on making an advantageous condition for vaporization of the engine directly in the combustion chamber 3 in the high-load section of the engine by controlling the amount of injection from the second injector 9 to be relatively large, thereby improving the output and fuel efficiency of the engine through supplying fuel to be suitable for both the high-load and low-load sections of the engine.

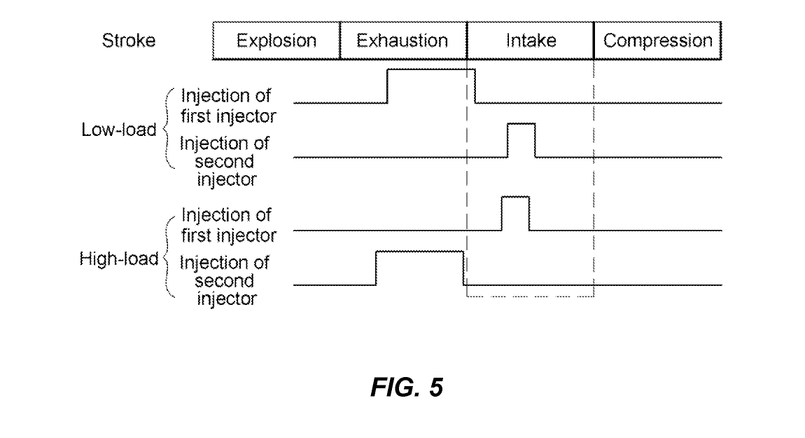

Therefore, the first injector 7 may inject fuel in the exhaustion of the corresponding cylinder and the second injector 9 injects fuel in the intake of the cylinder, that is compared by the example shown in FIG. 5.

The present invention provides two injectors that inject fuel in an intake port connected with one combustion chamber and allows overcoming the technical limitations of the related art and achieving more appropriate fuel injection in accordance with the operation sections of an engine, thereby improving fuel efficiency and output of the engine with more efficient operation.

For convenience in explanation and accurate definition in the appended claims, the terms upper or lower, and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. An engine with dual injectors comprising:
an intake port connected to and disconnected from a combustion chamber by an intake valve;
a first injector remotely disposed from the intake valve in the intake port; and
a second injector disposed under the intake port closer to the intake valve than the first injector in the intake port and injecting fuel into the intake port above the intake valve.

2. The engine of claim 1, wherein the intake port is composed of two intake ports connected with one combustion chamber while the first injector and the second injector are separately disposed in the intake ports, respectively.

3. The engine of claim 1, wherein the first injector is positioned at a distance from the intake valve which is longer than a predetermined reference distance to be suitable for mixing and vaporizing of fuel in a gas mixture in a low-load operation of the engine, and
the second injector is positioned far from the intake valve which is longer than the predetermined reference distance such that the fuel in the gas mixture is vaporized in the combustion chamber in a high-load operation of the engine.

4. The engine of claim 3, wherein the predetermined reference distance is set within a range of 45 mm±5 mm.

5. The engine of claim 1, wherein the first injector is disposed at the upper portion of the intake port and injects fuel into the intake port.

6. A method of controlling the engine with dual injectors of claims 1, comprising:
increasing the amount of injection from the first injector more than the amount of injection from the second injector in the low-load section of the engine; and
increasing the amount of injection from the second injector more than the amount of injection from the first injector in the high-load section of the engine.

7. The method of claim 6, wherein the first injector starts injecting in the exhaustion of a corresponding cylinder and the second injector starts injecting in the intake of the cylinder.
